(19) United States
(12) Patent Application Publication
(10) Pub. No.: US 2013/0111743 A1
(43) Pub. Date: May 9, 2013

(54) METHOD FOR MANUFACTURING FLAT COAXIAL CABLE

(71) Applicant: Chien-Han HO, Taipei City (TW)

(72) Inventor: Chien-Han HO, Taipei City (TW)

(21) Appl. No.: 13/290,373

(22) Filed: Nov. 7, 2011

(51) Int. Cl. H01B 13/20

(52) U.S. Cl. 29/828

(57) ABSTRACT

A method for manufacturing a flat coaxial cable includes the steps of: providing two composite layers having a first A aperture, a second A aperture, a first B aperture and a second B aperture; adhering the composite layers on a signal wire and exposing the signal wire through the apertures; forming two fill apertures penetrating through the two composite layers and filling a silver paste within the fill apertures; providing two outer cover layers having a first C aperture and a second C aperture, and respectively adhering the two outer cover layers on the two composite layers; and cutting the adhered signal wire, composite layers and outer cover layers along a direction perpendicular to the signal wire. Thus, the flat coaxial cable has two ends formed with a step-like structure defined by the signal wire, the composite layers and the outer cover layers.

### BACKGROUND OF THE INVENTION

1. Field of the Invention

The present invention relates a method for manufacturing a coaxial cable for use in transmitting high speed signals, and more particular to a method for manufacturing a flat coaxial cable.

2. The Prior Arts

A conventional coaxial cable includes a signal wire at a center thereof. The signal wire is enclosed by an insulation layer having a signal isolation layer at the outer periphery, and the outer periphery of the signal isolation layer is provided with an outer cover layer. The method for manufacturing the coaxial cable includes the steps of: stacking the layers, utilizing an extruding machine for extrusion and forming a coaxial cable with a round end surface, and manually peeling to expose the signal wire, the insulation layer and the signal isolation layer. This conventional manufacturing method is labor consuming.

However, the structure of the coaxial cable has a round end surface because of being extruded by the extruding machine. Thus, it is harder to be flatly installed on a board of an electronic product. Moreover, the coaxial cable has a predetermined diameter (thickness), so the housing of the electronic product has to be enlarged. Therefore, it is hard to minimize the size of the electronic product. Furthermore, it is hard to fasten the conventional coaxial cable on a board due to its round end surface.

After diligent research, the inventor of the present invention realizes that the structure of the coaxial cable can be altered by changing the method for manufacturing the coaxial cable.

### SUMMARY OF THE INVENTION

A primary objective of the present invention is to provide a method for manufacturing a flat coaxial cable that solves the shortcoming of the conventional method needing a peeling operation. The flat coaxial cable manufactured by the method according to the present invention includes a signal wire, an insulation layer, a signal isolation layer having pre-reserved lengths exposed at two ends, thereby saving the labor for the peeling operation in order to expose the signal wire and insulation layer.

Another objective of the present invention is to provide a method for manufacturing a flat coaxial cable. The flat coaxial cable manufactured by the method according to the present invention is provided with a membrane-like thin shape thereby solving the problem of the housing of an electronic product being enlarged due to the round end surface of a conventional coaxial cable, and solving the problem of the cable having round end surface being hard to be fastened on a board.

In order to achieve the above-mentioned objectives, a method for manufacturing a flat coaxial cable according to the present invention includes the steps of:

(S1): providing two composite layers having a first A aperture and a second A aperture, a first B aperture and a second B aperture;

(S2): providing a signal wire, symmetrically adhering the two composite layers on a top and a bottom of the signal wire, and exposing the signal wire through the first A apertures, the second A apertures, the first B apertures, and the second B apertures;

(S3): forming two fill apertures, which penetrate through the two composite layers and are respectively disposed at two sides of the signal wire, and filling a silver paste within the fill apertures;

(S4): providing two outer cover layers having a first C aperture and a second C aperture, aligning the first C apertures with the first A apertures and the first B apertures, aligning the second C apertures with the second A apertures and the second B apertures, and respectively adhering the two outer cover layers on the two composite layers; and

(S5): cutting the adhered signal wire, composite layers and outer cover layers along a direction perpendicular to the signal wire; wherein the cutting lines passes through the first A apertures, the second A apertures, the first B apertures and the second B apertures of the composite layers, and the first C apertures and the second C apertures of the outer cover layers.

Each of the above-mentioned composite layers has an insulation layer and a signal isolation layer. The first A aperture and the second A aperture are formed on the insulation layer, and the first B aperture and the second B aperture are formed on the signal isolation layer. The first C aperture and a second C aperture are formed on the outer cover layer. The dimension of the apertures of the outer cover layer is larger than that of the apertures of the signal isolation layer, and the dimension of the apertures of the signal isolation layer is larger than that of the apertures of the insulation layer, so a step-like structure is formed in the apertures by the signal wire, the insulation layer, the signal isolation layer and the outer cover layer. Therefore, after being cut, a flat coaxial cable having the signal wire, the insulation layers and the signal isolation layers with pre-reserved lengths exposed at two ends is formed, and can be directly connected with terminals at the two ends for saving the labor required by the peeling operation.

The insulation layer, the signal isolation layer and the outer cover layer are made to a membrane-like shape, and mutually adhered for forming a cable which is light and thin, occupies less space and allows the design of the housing of an electronic product to be thinner. In addition, the flat coaxial cable provided by the present invention can be flatly installed on a board inside the electronic product. Thus, it is easier to be fastened compared to the conventional coaxial cable having the round end surface.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart showing a method for manufacturing a flat coaxial cable according to the present invention;

FIG. 2 is a top view showing a composite layer;

FIG. 2A is a cross sectional view taken along line 2A-2A in FIG. 2;

FIG. 3 is a top view showing the composite layers being in contact with a signal wire;

FIG. 3A is a cross sectional view taken along line 3A-3A in FIG. 3;

FIG. 4 is a top view showing the composite layers being formed with fill apertures;

FIG. 4A is a cross sectional view taken along line 4A-4A in FIG. 4;

FIG. 5 is a top view showing the composite layers being provided with outer cover layers;

FIG. 5A is a cross sectional view taken along line 5A-5A in FIG. 5;

FIG. 6 is a schematic view showing the cutting direction;

FIG. 6A is a cross sectional view showing a finished product manufactured by the method according to the present invention;

FIG. 7 is a schematic view showing the mass production before the cables being cut; and

FIG. 8 is a schematic view showing the flat coaxial cable being connected with terminals.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

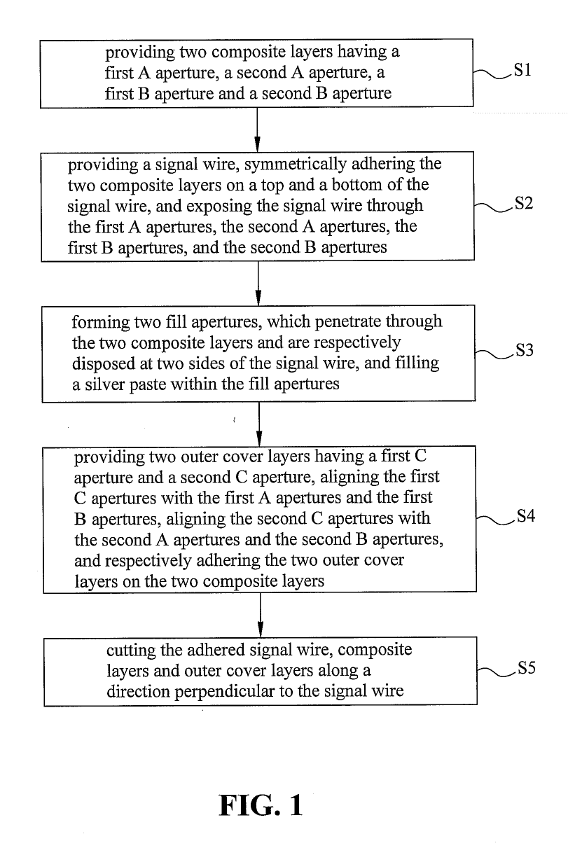

FIG. 1 is a flow chart showing a method for manufacturing a flat coaxial cable according to the present invention. The method includes the steps of:

(S1): providing two composite layers 1 having a first A aperture 111, a second A aperture 112, a first B aperture 121 and a second B aperture 122;

(S2): providing a signal wire 2, symmetrically adhering the two composite layers 1 on a top and a bottom of the signal wire 2, and exposing the signal wire 2 through the first A apertures 111, the second A apertures 112, the first B apertures 121, and the second B apertures 122;

(S3): forming two fill apertures 13, which penetrate through the two composite layers 1 and are respectively disposed at two sides of the signal wire 2, and filling a silver paste within the fill apertures 13;

(S4): providing two outer cover layers 4 having a first C aperture 41 and a second C aperture 42, aligning the first C apertures 41 of the two outer cover layers 4 with the first A apertures 111 and the first B apertures 121 of the two composite layers 1, aligning the second C apertures 42 of the two composite layers 1 with the second A apertures 112 and the second B apertures 122 of the two composite layers 1, and respectively adhering the two outer cover layers 4 on the two composite layers 1; and

(S5): cutting the adhered signal wire 2, composite layers 1 and outer cover layers 4 along a direction perpendicular to the signal wire 2, wherein one of cutting lines passes through the first A apertures 111, the first B apertures 121 and the first C apertures 41, and another cutting line passes through the second A apertures 112, the second B apertures 122 and the second C apertures 42.

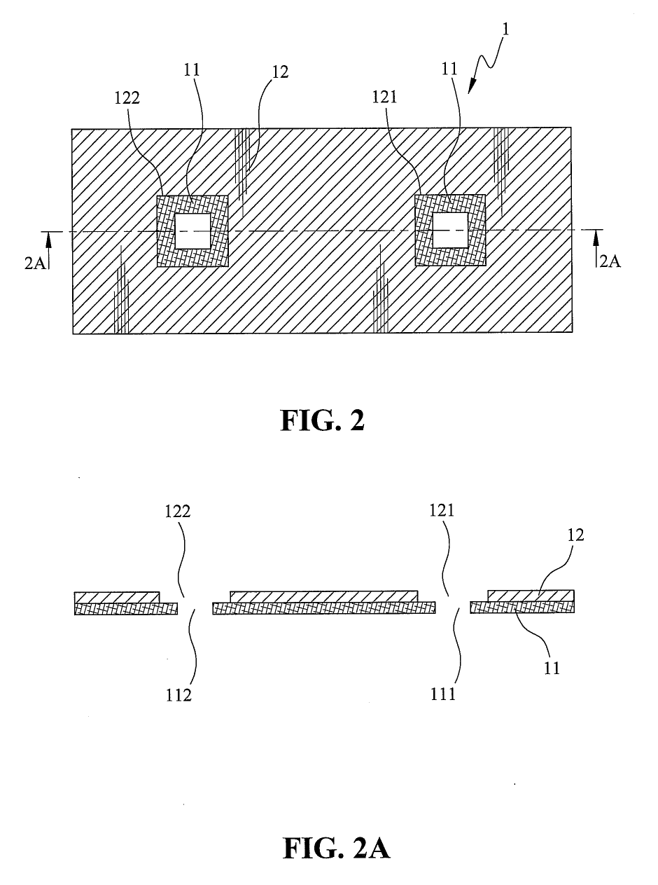

Referring to FIGS. 2 and 2A, the composite layers 1 disclosed in the step of (S1) includes an insulation layer 11 and a signal isolation layer 12. The insulation layer 11 and the signal isolation layer 12 are formed with a first A aperture 111 and a second A aperture 112, and a first B aperture 121 and a second B aperture 122, respectively. The apertures 111, 112, 121 and 122 can be rectangular in shape. The sizes of the first B aperture 121 and the second B aperture 122 of the signal isolation layer 12 are larger than that of the first A aperture 111 and the second A aperture 112 of the insulation layer 11, respectively. The surface of the signal isolation layer 12 is pre-printed with an isolation pattern (not shown in drawings) by the silver paste for preventing the interference of noise signal. After the first A aperture 111 of the insulation layer 11 is aligned with the first B aperture 121 of the signal isolation layer 12, and the second A aperture 112 is aligned with the second B aperture 122, the insulation layer 11 and the signal isolation layer 12 are adhered together by a thermal melting adhesive. As shown in FIG. 2, a part of the insulation layer 11 can be seen through the first B aperture 121 and the second B aperture 122 of the signal isolation layer 12, and therefore a step-like structure is formed between the signal isolation layer 12 and the insulation layer 11. Both of the signal isolation layer 12 and the insulation layer 11 are made to a membrane with large dimension. Thus, in the mass production, the membrane of the insulation layer 11 is formed with multiple sets of the first A apertures 111 and the second A apertures 112 that are arranged in rows. In the same way, the membrane of the signal isolation layer 12 is formed with multiple sets of the first B apertures 121 and the second B apertures 122 that are arranged in rows. The positions of the first A apertures 111 and the second A apertures 112 are corresponding to that of the first B apertures 121 and the second B, respectively. In the drawings, only one set of the apertures 111, 112, 121 and 122 is adopted for illustration. The signal isolation layer 12 may be made of an electric conductive plastic membrane, and the insulation layer 11 may be made of a PI plastic membrane, a Teflon membrane, a rubber membrane or a PVC membrane.

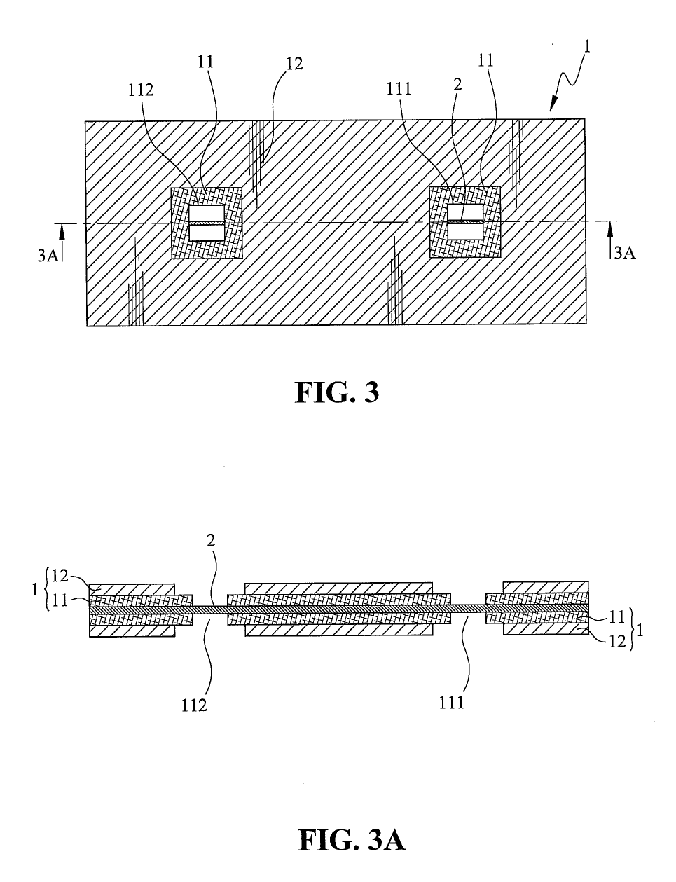

FIG. 3 is a top view showing one of the composite layers 1 contacted with the signal wire 2, and FIG. 3A is a cross sectional view showing the two composite layers 1 adhered with the signal wire 2. According to the step of (S2), the signal wire 2 is disposed between the two sets of symmetrical composite layers 1, and the signal wire 2 is in contact with the insulation layers 11 of the composite layers 1. The signal wire 2 is exposed through the first A apertures 111 and the second A apertures 112 of the insulation layers 11. The two composite layers 1 are adhered together by the thermal melting adhesive, such that the signal wire 2 is enclosed in the two composite layers 1. In addition, the signal wire 2 may be made of copper and the signal wire 2 can be formed as a single signal wire or plural signal wires jointly enclosed. The end surface of the signal wire 2 can be round or oval in shape for reducing the volume of the flat coaxial cable.

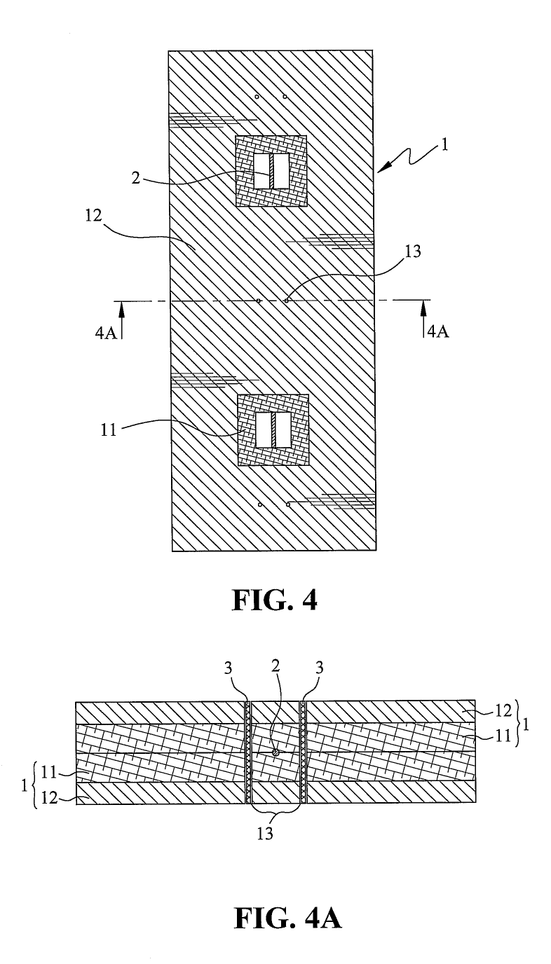

FIGS. 4 and 4A are a top view and a cross sectional view showing the composite layers 1 being formed with fill apertures. According to the step of (S3), after the top and the bottom composite layers 1 are adhered, two sides of the signal wire 2 are formed with multiple couples of the fill apertures 13 penetrating through the two composite layers 1. The two fill apertures 13 are disposed at two sides of the signal wire 2, respectively. The fill aperture 13 is very small in dimension and mainly provided for being filled with the silver paste 3, so the signal isolation layers 12 at the top and the bottom are connected with each other, thereby effectively preventing the interference of noise signal and achieving a better shielding effect.

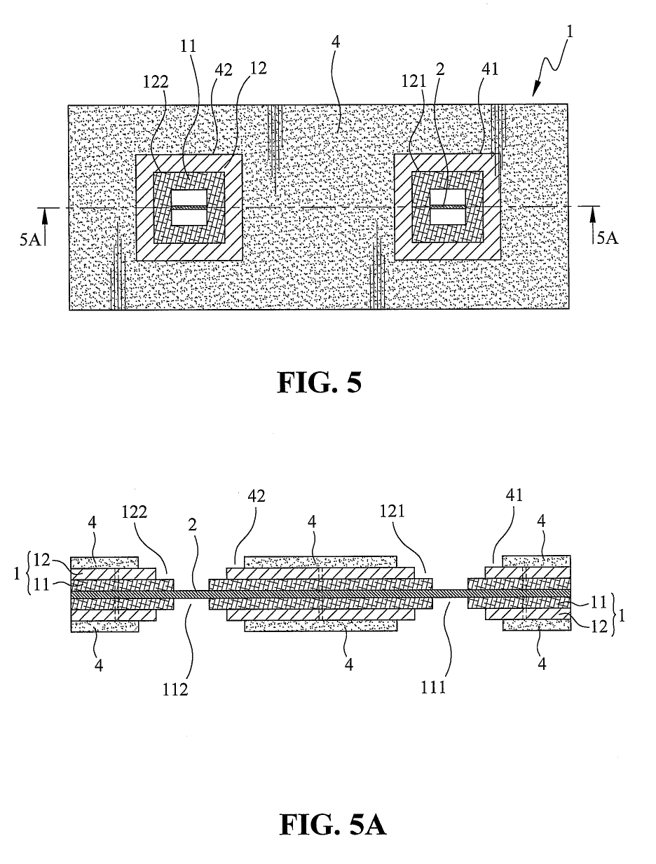

FIGS. 5 and 5A are a top view and a cross sectional view showing the composite layers 1 being adhered with the outer cover layers 4. According to the step of (S4), two outer cover layers 4 are provided, and each outer cover layer 4 has the first C aperture 41 and the second C aperture 42. The dimensions of the first C aperture 41 and the second C aperture 42 are larger than that of the first B aperture 121 and the second B aperture 122 of the signal isolation layer 12, respectively. When being adhered, the first C aperture 41 of the outer cover layer 4 is aligned with the first B aperture 121 of the signal isolation layer 12, and the second C aperture 42 of the outer cover layer 4 is aligned with the second B aperture 122 of the signal isolation layer 12. As shown in FIG. 5, a part of the signal isolation layers 12 and a part of the insulation layers 11 are exposed through the first C apertures 41 and the second C apertures 42 of the outer cover layers 4. Therefore, a step-like structure is formed between the insulation layers 11, the signal isolation layers 12 and the outer cover layers 4 as shown in FIG. 5A. The outer cover layer 4 is also made to a membrane with a large dimension, so in the mass production, the outer cover layer 4 can be formed with a plurality of the first C apertures 41 and the second C apertures 42, which are arranged in rows with intervals. The outer cover layer 4 can be made of a PI plastic membrane, a Teflon membrane, a rubber membrane or a PVC membrane. The outer cover layers 4 are adhered onto the composite layers 1 with the thermal melting adhesive.

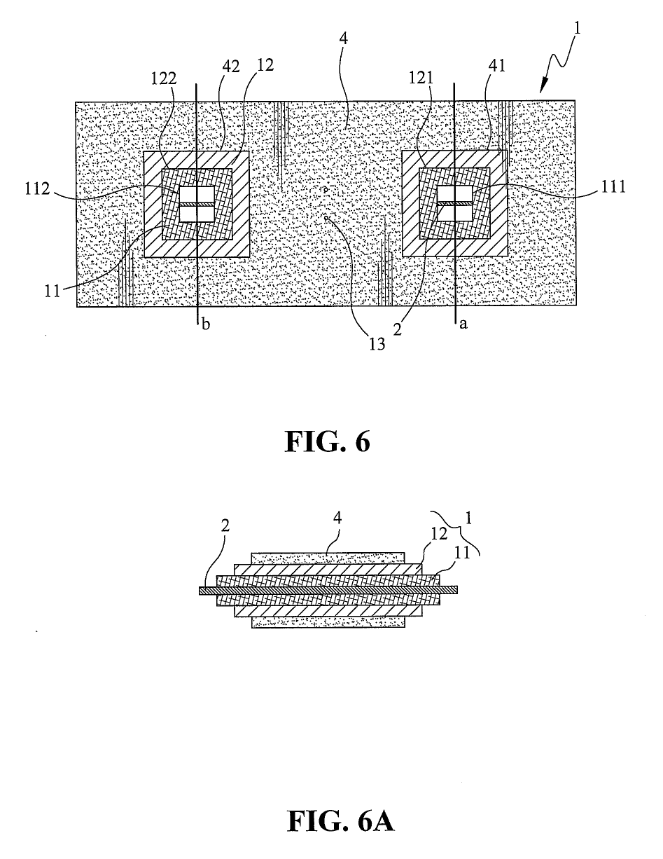

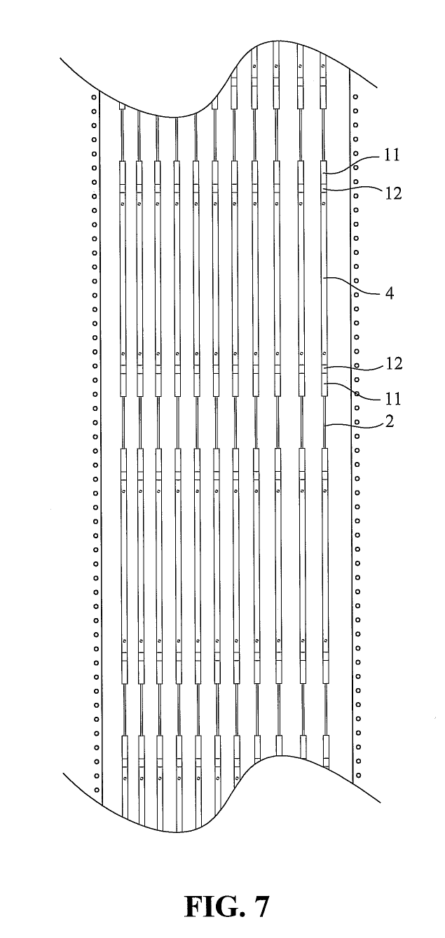

FIGS. 6 and 6A show the steps of cutting the composite layers 1, the signal wire 2 and the outer cover layers 4. FIG. 6 illustrates the cutting direction. The cutting is processed by cutting two cutting lines (line a and line b) along a direction perpendicular to the signal wire 2. One of the cutting lines (the line a) passes through centers of the first A apertures 111 and the first B apertures 121 of the composite layers 1 and the first C apertures 41 of the outer cover layer 4, and the other cutting line (the line b) passes through centers of the second A apertures 112 and the second B apertures 122 of the composite layers 1 and the second C apertures 42 of the outer cover layers 4. As such, the flat coaxial cable with a proper length is obtained as shown in FIG. 6A. The signal wire 2, the insulation layers 11, the signal isolation layers 12 and the outer cover layers 4, which form a step-like structure, can be seen at two ends of the flat coaxial cable. The width of the flat coaxial cable is corresponding to the actual needs, as long as the flat coaxial cable still has the fill apertures 13. The drawings are adopted for illustration only. In the actual mass production, please refer to FIG. 7, which is a schematic view showing the mass production before the flat coaxial cables being cut. Moreover, according to the embodiment of the present invention, the insulation layer 11, the isolation layer 12 and the outer cover layer 4 are adhered as a three-layer stack, and the signal wire 2 is disposed between the two stacks. In the actual manufacture, the quantity of the insulation layer 11, the isolation layer 12 and the outer cover layer 4 can be varied according to the product specification requirement by a manufacturer.

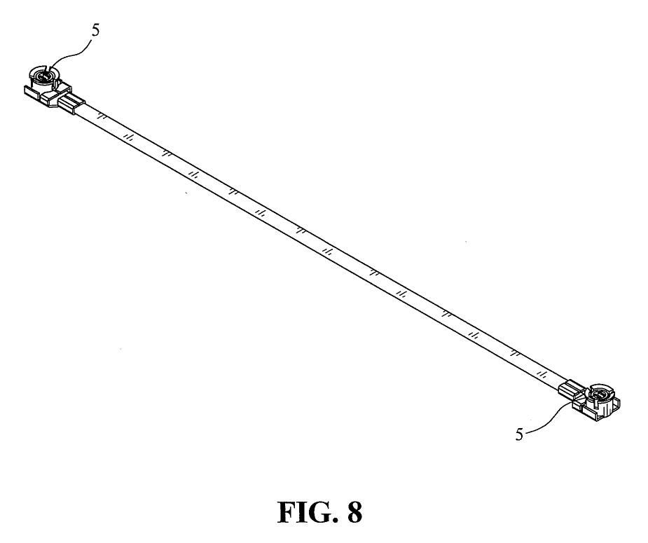

FIG. 8 is a schematic view showing the flat coaxial cable according to the present invention being connected with terminals 5. Referring to FIG. 6A and FIG. 8, the flat coaxial cable has two ends and each end of the flat coaxial cable has a step-like structure formed by the signal wire 2, the insulation layer 11, the signal isolation layer 12 and the outer cover layer 4. Thus, each of the step-like structures can be directly connected with the terminal 5 for connecting two electronic equipments (not shown) spaced with a distance.

The feature of the flat coaxial cable according to the present invention is that both ends of the flat coaxial cable have exposed step-like structures. Thus, the signal wire 2, the insulation layer 11, the signal isolation layer 12 can be directly connected to the terminal 5, thereby saving the conventional process of peeling a coaxial cable for the purpose of exposing each layer. Moreover, the materials for the insulation layer 11, the signal isolation layer 12 and the outer cover layer 4 are made to membranes, and the signal wire may have an oval end surface, so the finished product of flat coaxial cable according to the present invention is thinner than the conventional coaxial cable having a round end surface made through extrusion. Therefore, the flat coaxial cable according to the present invention occupies less space, and the housing of an electronic product can be designed to be thinner. In addition, the flat coaxial cable according to the present invention can be flatly installed on a board inside the electronic product, and therefore it is easier to be fastened compared to the conventional coaxial cable having the round end surface.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for manufacturing a flat coaxial cable, including the steps of:
(S1): providing two composite layers having a first A aperture, a second A aperture, a first B aperture and a second B aperture;
(S2): providing a signal wire, symmetrically adhering the two composite layers on a top and a bottom of the signal wire, and exposing the signal wire through the first A apertures, the second A apertures, the first B apertures, and the second B apertures;
(S3): forming two fill apertures, which penetrate through the two composite layers, and filling a silver paste within the fill apertures;
(S4): providing two outer cover layers having a first C aperture and a second C aperture, aligning the first C apertures with the first A apertures and the first B apertures, aligning the second C apertures with the second A apertures and the second B apertures, and respectively adhering the two outer cover layers on the two composite layers; and
(S5): cutting the adhered signal wire, composite layers and outer cover layers along a direction perpendicular to the signal wire, wherein one of cutting lines passes through the first A apertures, the first B apertures and the first C apertures, and another cutting line passes through the second A apertures, the second B apertures and the second C apertures.

2. The method according to claim 1, wherein each of the composite layers comprises an insulation layer and a signal isolation layer, the insulation layer includes the first A aperture and the second A aperture, the signal isolation layer includes the first B aperture and the second B aperture, dimensions of the first B aperture and the second B aperture are respectively larger than that of the first A aperture and the second A aperture.

3. The method according to claim 2, wherein the signal wire is disposed between and in contact with the two insulation layers.

4. The method according to claim 3, wherein the silver paste filled within the fill apertures connects the two signal isolation layers, for forming a shield to prevent an interference of noise signal.

5. The method according to claim 3, wherein each outer cover layer is adhered with the signal isolation layer, and dimensions of the first C aperture and the second C aperture of the outer cover layer are respectively larger than that of the first B aperture and the second B aperture of the signal isolation layer.

6. The method according to claim 5, wherein after cutting the adhered signal wire, composite layers and outer cover layers, the flat coaxial cable is provided with a step-like structure at two ends, the step-like structure is defined by the signal wire, the insulation layer, the signal isolation layer and the outer cover layer being arranged from an inner side to an outer side.

7. The method according to claim 2, wherein the insulation layer, the signal isolation layer and the outer cover layer are membranes.

8. The method according to claim 2, wherein the cable comprises more than one signal wires.

9. The method according to claim 2, wherein an end surface of the signal wire is round or oval in shape.

10. The method according to claim 2, wherein the signal wire is made of copper.

11. The method according to claim 2, wherein the signal isolation layer is made of an electric conductive plastic membrane.

12. The method according to claim 2, wherein the insulation layer is made of a PI plastic membrane, a Teflon membrane, a rubber membrane or a PVC membrane.

13. The method according to claim 2, wherein the outer cover layer is made of a PI plastic membrane, a Teflon membrane, a rubber membrane or a PVC membrane.

14. The method according to claim 7, wherein before the signal isolation layer and the insulation layer are combined to form the composite layer, the signal isolation layer is pre-printed with an isolation pattern by the silver paste for preventing the interference of noise signal.

15. The method according to claim 1, wherein the adhering in the steps of (S2) and the (S4) is adhered by a thermal melting adhesive.
